(19) United States
(12) Patent Application Publication
(10) Pub. No.: US 2013/0216216 A1
(43) Pub. Date: Aug. 22, 2013

(54) OPTICAL NETWORK NODE WITH RESTORATION PATH

(71) Applicants: Giulio Bottari, Livorno (IT); Paola Iovanna, Roma (IT)

(72) Inventors: Giulio Bottari, Livorno (IT); Paola Iovanna, Roma (IT)

(73) Assignee: TELEFONAKTIEBOLAGET L M, Stockholm (SE)

(21) Appl. No.: 13/701,613

(22) PCT Filed: Jun. 16, 2010
(86) PCT No.: PCT/EP2010/058444

§ 371 Date: Feb. 11, 2013

(30) Foreign Application Priority Data
Jun. 3, 2010 (EP) 10164838.4

(51) Int. Cl. H04B 10/038

(52) U.S. Cl. CPC H04B 10/038
USPC 398/5

(57) ABSTRACT

A node for an optical network has an electrical selector (30, 35) coupled to a first transponder for selecting which of first or second connections, is carried. A connection controller (80, 130) cooperates with other nodes to set up the first connection on a main path using a second transponder, and to reserve a first restoration path for the first connection. A second connection (best effort traffic) is set up on at least part of the reserved first restoration path by controlling the electrical selector. If the main path fails, the first connection is restored by controlling the electrical selector to select the first connection for the first restoration path in place of the second connection. By having an electrical selector, a change can be made more rapidly than if done only optically.

### TECHNICAL FIELD

This invention relates to nodes for wavelength switched optical networks, to connection controllers for setting up connections between nodes in such networks, to methods of operating nodes as ingress nodes and egress nodes to set up connections, and to corresponding programs.

### BACKGROUND

A concept of shared mesh restoration is defined in RFC4427 (“a particular case of pre-planned LSP re-routing that reduces the restoration resource requirements by allowing multiple restoration LSPs to share common resources”). This refers to a way to efficiently recover a set of working paths using a bundle of shared resources. This is possible thanks to the control plane which manages these resources also in case of multidomain network partitioning.

It is known from US 2009285574 to provide end to end recovery across multiple domains. A primary protection circuit group (PCG) may be setup using one of several control plane protection schemes, including, for example, unprotected, mesh or SONET/SDH 1+1 protected with full SRLG (shared risk link group) diversity and full node diversity, mesh 1+1 protected with full SRLG diversity and best-effort node diversity, mesh 1+1 protected with full SRLG diversity and no node diversity, or a full-time 1+1 protection. PCG bandwidth can be used to transport select customer traffic when the bandwidth is not used to protect ACG circuits (i.e., some bandwidth may be used to support extra traffic).

U.S. Pat. No. 6,795,394 shows networks having protection paths for extra traffic, when the protection paths are not being used for working traffic, the nodes being arranged to use one or more of the protection paths for working traffic in the event of a fault on one of the working paths, and thus displace extra traffic from the protection path or paths used by the working traffic, the nodes further being arranged to use an alternative path to protect at least some of the displaced extra traffic.

### SUMMARY

An object of the invention is to provide improved apparatus or methods. According to a first aspect, the invention provides:

An ingress node for a wavelength switched optical network, the node having three or more optical line ports for multiplexing wavelengths to carry traffic to other nodes of the network, and an optical switch coupled to the optical line ports for selectively coupling different wavelengths from one of the optical line ports, to others of the optical line ports. First and second interfaces are provided for receiving the traffic to be carried on the wavelengths to the other nodes, and a first transponder is provided for converting electrical signals carrying the traffic from either of the interfaces into wavelengths carrying the traffic for output to the other nodes via the optical switch and the optical line ports. An electrical selector is coupled to the first and second interfaces, and arranged to pass traffic selectively from either the first or the second interface to the first transponder. A second transponder is coupled to the first interface, for converting electrical signals carrying the traffic from the first interface into wavelengths carrying the traffic for output to the other nodes via the optical switch and the optical line ports. The node also has a connection controller arranged to cooperate with other nodes to set up a first connection for the traffic over a main path from the first interface through at least the second transponder and the optical switch, and to reserve a first restoration path for the first connection from the first interface through at least the electrical selector, the first transponder, and the optical switch. The connection controller is also arranged to set up a second connection from the second interface on at least part of the reserved first restoration path by controlling the electrical selector to couple the traffic from the second interface to the first transponder. If the main path fails, the connection controller restores the first connection by controlling the electrical selector to pass traffic from the first interface to the first transponder.

By having an electrical selector for selecting which connection uses which transponder, a change can be made more rapidly than if done only optically, by using a different wavelength, or by coupling a different optical source, onto a given optical path, as there would need to be a delay to allow optical power control or dispersion control for example, to settle. By having the electrical selector under the control of the connection controller, rather than as an automatic protection switch, it can thus be part of a network wide routing scheme for making more use of the reserved and possibly shared restoration paths. This can enable more efficient use of wavelength resources.

Any additional features can be added to those discussed above, and some are described in more detail below.

Another aspect of the invention can involve an egress node for a wavelength switched optical network, the node having three or more optical line ports, for de multiplexing wavelengths carrying traffic from other nodes of the network, and an optical switch coupled to the optical line ports for selectively coupling different wavelengths from one of the optical line ports, to others of the optical line ports. First and second interfaces are provided for the traffic dropped from the wavelengths received from the other nodes. A first transponder is coupled to the optical switch for converting wavelengths from the optical switch carrying the traffic to be dropped, into electrical signals to pass to either of the interfaces. An electrical selector is coupled to the first transponder and arranged to pass the traffic from the first transponder selectively to either the first or to the second interface. A second transponder is coupled to the optical switch, for converting wavelengths from the optical switch carrying the traffic to be dropped, into electrical signals to pass to the first interface. The node also has a connection controller arranged to cooperate with other nodes to set up a first connection for the traffic over a main path to the first interface through at least the second transponder and the optical switch, and to reserve a first restoration path for the first connection to the first interface through at least the optical switch, the first transponder, and the electrical selector, the connection controller also being arranged to set up a second connection to the second interface on at least part of the reserved first restoration path by controlling the electrical selector to couple the traffic to the second interface from the first transponder. If the main path fails, the connection controller is arranged to restore the first connection by controlling the electrical selector to pass traffic from the first transponder to the first interface.

Another aspect provides a connection controller for setting up connections between nodes in a wavelength switched optical network having wavelength multiplexed optical paths between optical line ports of neighbouring nodes of the network, at least an ingress node and an egress node having an optical switch coupled to the optical line ports for selectively coupling different wavelengths from one of the ports, to the other ports, and first and second transponders for electrical to optical conversion in the ingress node and for optical to electrical conversion in the egress node. An electrical selector is coupled to the first of the transponders for selecting which of the first and second connections uses the first of the transponders. The ingress node has first and second interfaces and the egress node has first and second interfaces. The connection controller has a processor and a communications interface for cooperating with the nodes of the network, the processor being arranged to use the communications interface to cooperate with the nodes to set up the first connection on a main path using the second transponders at the ingress node and at the egress node. The processor is also arranged to reserve a first restoration path for the first connection from the first interface through the electrical selector to the first transponder at the ingress node and the first transponder at the egress node to the electrical selector and then to the first interface, and to set up the second connection on at least part of the reserved first restoration path by controlling the electrical selectors at the ingress node and the egress node to couple the second connection from the second interface through the electrical selector, through the first transponder, and at the egress node through the first transponder and through the electrical selector to the second interface. The processor is also arranged to restore the first connection using the first restoration path if the main path for the first connection fails, by controlling the electrical selector in the ingress node to couple the first interface to the first transponder and by controlling the electrical selector in the egress node to couple the first transponder to the first interface.

Another aspect provides a corresponding method of operating an ingress node, and a corresponding method of operating an egress node.

Another aspect provides computer readable instructions on a computer readable medium, which when executed by a processor cause the processor to carry out the method.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIGS. 1 and 2 show schematic views of a network having nodes according to a first embodiment,

FIG. 3 shows steps according to an embodiment,

FIG. 4 shows a schematic view of a node according to an embodiment,

FIGS. 5 and 6 show schematic views of a node according to an embodiment,

FIG. 7 shows another node view,

FIGS. 8, 9, and 10 show embodiments having multiple connections sharing the same restoration path,

FIGS. 11 to 14 show embodiments having three way restoration,

FIG. 15 shows an embodiment having an example of shared three-way restoration,

FIG. 16 shows an embodiment having an example of protection switching on the main paths, and

FIG. 17 shows an embodiment having the restoration path shared by main paths having different end nodes.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

### ABBREVIATIONS

E2E End to End
HSI High Speed Internet
LSP Label Switched Path
QoS Quality of Service
OSNCP Optical Sub Network Connection Protection
OTN Optical Transport Network
RFC Request For Comment
ROADM Reconfigurable Optical Add Drop Multiplexer
VOIP Voice Over IP
VOD Video On Demand
WSON Wavelength Switched Optical Network
WSS Wavelength Selective Switch

### DEFINITIONS

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to switching nodes can encompass any kind of switching node, not limited to the types described, not limited to any level of integration, or size or bandwidth or bit rate and so on.

References to software can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on.

References to a transponder can encompass unidirectional converters or bidirectional converters, and may encompass those which add or remove framing, or otherwise, and those which select or multiplex wavelengths for example.

References to connection controllers or connection control parts can encompass any kind of controller for setting up connections, including distributed or centralized types.

References to connections or connection oriented protocols are intended to encompass any way of transmitting data where the end points set up an end to end connection as a preliminary step before transmitting data, and keep track of a state of message exchange, as opposed to connection-less protocols.

### Introduction

By way of introduction to the embodiments, some issues with conventional designs will be explained.

### Multiple-Class Services

The setup of end to end (E2E) services across multiple domains typically requires Quality of Service (QoS) guaranteed services and/or best effort services. In the latter case, data will be delivered to their destination as soon as possible, but with no commitment as to bandwidth and latency. The following Table 1 resumes possible QoS requirements of different services as a general reference.

TABLE 1
Example of Service Levels

| | | Video On | |
|---|---|---|---|
| | Voice Over IP | Demand | High Speed |
| | (VoIP) | (VOD) | Internet (HSI) |
| E2E Delay | <=40 ms | <=200 ms | Non real time, |
| E2E Jitter | <=10 ms | <=1 ms | best effort. |
| Packet Loss | <0.1% | <0.1% | |

In a realistic scenario, the service provisioning is delivered across a multi-domain/multi-in technology network where the optical domain (WSON) ensures the transport service. Here one of the tasks of the control plane for the WSON domain is to manage the fault recovery in the (transparent or translucent) optical switched network area. There can be a mix of services, as indicated in Table 1, across multiple domains such as different packet networks or connection based networks, where the intermediate domain is based on the optical switched technology.

### Shared Mesh Restoration

The emerging WSON solution offers a variety of restoration schemes allowing a very efficient bandwidth management to provide good network survivability thanks to cost-effective recovery strategies. In particular, the resources reserved for the recovery of a worker (also called main or primary) light path can be shared with other worker lightpaths if all these worker paths do not have any resource in common (path disjointness). This technique is generally known as “shared mesh restoration” and it's defined in RFC4427 “Recovery (Protection and Restoration) Terminology for Generalized Multi-Protocol Label Switching (GMPLS)”.

In traditional photonic, where the network was not controlled by a control plane, the most widely used recovery mechanism was the 1+1 protection OSNCP. This scheme relies, on the network side, on a couple of fixed transponders and on an electrical selector. Both transponders inject traffic along two lightpaths, worker and protection, and the selector sets the receiving way.

In an OSNCP scheme, being a classic 1+1 protection, there is no way to share protection resources among different workers. Loss of traffic in case of failure is kept at minimum because of fast switching from worker to protection, but all this is achieved at the price of doubling up the bandwidth (i.e. transport resources) actually used for the service.

Thanks to the WSON control plane, new recovery schemes are possible where the recovery resources are only booked. They are activated (cross-connected) only in case of failure (unidirectional of bidirectional). As a consequence, recovery resources can be shared among different worker lightpaths: this allows resource sharing in the recovery domain.

For all optical networks without wavelength conversion and colorless capabilities, restoration resources may have to be shared on a per-wavelength basis. However a WSON node (like ROADM) may include wavelength converters: these are usually arranged into some type of pool to further enhance resource sharing and to allow a more flexible wavelength assignment.

Three schemes with potential resource sharing can be envisaged in the WSON domain. They are: transponder sharing (two main paths shares one backup paths), 3-way restoration (two main paths share two backup paths), safe OSNCP (two main paths share four backup paths).

Problems with Existing Solutions

Currently, to support the delivery of best effort services across the optical domain, two different strategies are considered:

a) The use of unprotected lightpaths: a wavelength, and the relevant hardware resources, is used to provide the end to end connection in the optical domain. If a fault occurs the transported traffic is lost.
b) If the optical domain does not differentiate among the traffic transported across the domain itself, it can happen that the best effort service is transported using a lightpath whose survivability is enhanced thanks to one of the several WSON recovery scheme.

In this case an excessive service level is ensured to the best effort service with a consequent cost rise.

### FEATURES OF EMBODIMENTS

Embodiments of the current invention can have an apparatus configuration (in ROADMs for example) to deliver best effort services using the pool of shared resources which are planned for recovery purposes. In case of failure, such shared resources are used for the planned recovery purposes and the best effort traffic is disrupted and not delivered until the failure is present.

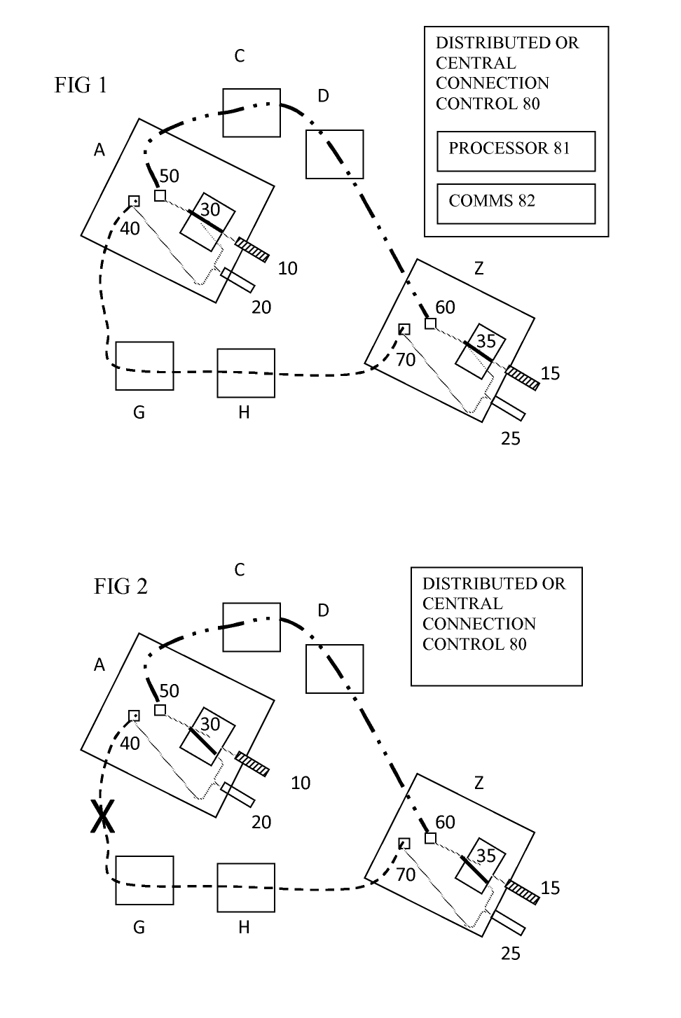

### FIGS. 1, 2, 3 a First Embodiment

FIG. 1 shows an overview of some parts of an optical network, including nodes A, C, D, G, H, and Z. Nodes A and Z are shown in more detail than other nodes. Node A has a connection oriented electrical selector 30, a first transponder 50, and a second transponder 40. There may be other parts not shown here for the sake of clarity. Item 20 represents a first interface which can be an interface for ingress to an ingress node or for egress from an egress node. Traffic to be transported across the network can be coupled into the node here or in the other direction, traffic can be dropped from the network here. A first connection for this traffic can be set up between this first interface and a corresponding first interface in the other end node for that connection.

Item 10 represents a second interface which can also be either for ingress to an ingress node or egress from an egress node. A second connection for this traffic can be set up between this interface and a corresponding second interface in the other end node for this connection. The traffic using this second connection can be a lower priority class of traffic. The electrical side of transponder 40 is coupled electrically to the interface 20 for the first connection. The optical side of transponder 40 is coupled to an optical path (shown as a dashed line) from node A through nodes G and H to second transponder 70 in node Z. This optical path can be bidirectional, or unidirectional. The transponder 70 is coupled electrically to an interface 25 for the first connection. Node Z also has a first transponder 60 and a connection oriented selector 35, arranged to select either the first connection or the second connection for coupling to the first transponder 60. A complete optical path (shown as a double dot dash line) has been set up from transponder 50 through nodes C and D to transponder 60. This is usable as a restoration path for the first connection.

FIG. 1 also shows a distributed or central connection control part, arranged to set up the paths for the connections. This can be implemented as a distributed control plane or as part of the network management, following established practice. It is shown as having a processor 81 and a communications interface 82 for cooperating with the nodes, or for cooperating with other parts in a distributed example. This controller is distinguished by being arranged to control the electrical selectors in nodes A and Z. As shown in FIG. 1, the selectors 30 and 35 are set to couple the second connection onto the restoration path. In FIG. 2, the same network configuration is shown, but with a fault on the optical path between node A and G. The electrical selectors have both been switched so that the first connection is routed over the restoration path. The second connection is disconnected, or at least loses some of its capacity, but continues to operate using whatever capacity remains unused by the higher priority first connection.

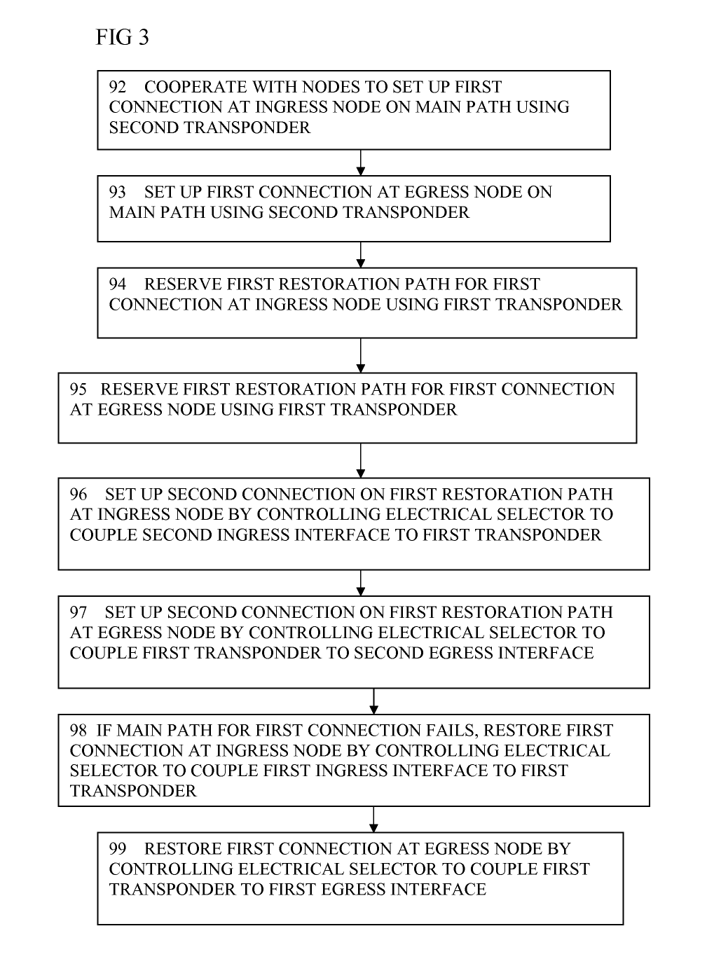

FIG. 3 shows another illustration of this process in the form of steps by the connection control part according to an embodiment. At step 92, the connection controller cooperates with nodes along the path to set up the first connection on a main path using the second transponder at the ingress node, say node A. At step 93, the first connection is set up at the egress node, say node Z. At step 94, the control part reserves a first restoration path for the first connection using the first transponder at the ingress node.

At step 95, the first restoration path is set up at the egress node using the first transponder at the egress node. The path for the second connection is then set up at step 96 using at least part of the first restoration path, and using the electrical selector at the ingress node to couple the second interface to the first transponder. At step 97, the path for the second connection is set up at the egress node using the electrical selector at the egress node to couple the first transponder to the second interface.

At step 98, if the path for the first connection fails, as shown in FIG. 2, then the connection control part causes the electrical selector to couple the first interface at the ingress node to the first transponder in place of the second connection. At step 99, the connection control part causes the electrical selector to couple the first transponder at the egress node to the first interface. In at least some cases, there will be no need to alter settings at intermediate nodes, if the first and second connections have the same end nodes, if there is no need to make optical changes along the first restoration path, and thus no need for delays caused by waiting for optical power changes to settle. This applies even if there is some electrical or optical regeneration along the restoration path. A consequence of the controller setting up a connection is that the state of the connection can be maintained and managed, and the data sent and received can be maintained in a given order, and not confused with data from different connections.

### Additional Features of Some Embodiments

In some cases the transponders can comprise non tunable transponders, for transmitting and receiving a fixed wavelength. In other cases the transponders can comprise tunable transponders, controllable by the connection controller to transmit different wavelengths. This can add further flexibility to make more efficient use of resources.

The optical switch can have at least some fixed wavelength paths, so that a respective wavelength at one input of the optical switch is always directed to the same output. This helps avoid the complexity and settling delays of having a selectable output.

The optical switch can have some selectable wavelength paths, so that a respective wavelength at one input of the optical switch is directed to either of two or more outputs of the optical switch, under the control of the connection controller. This can help provide more flexibility, to enable more possible paths for connections and thus enable the wavelength resources to be deployed more efficiently or to fit the demand more closely.

The node can have a third transponder for coupling a third wavelength between the optical switch and a third connection, the third connection also being coupled to the electrical selector so that the electrical selector can select whether the first or second or third of the connections is coupled with the first wavelength via the first transponder. This can enable the first wavelength to be used as a shared restoration path, for restoring either the first or the third connections.

The connection controller can be arranged to cooperate with other nodes to reserve an alternative restoration path for restoration of the first connection, and to control the electrical switch or the transponder or the optical switch to couple the first connection to the alternative restoration path to restore the first connection if the first restoration path is faulty. This provides so called three-way restoration so that the first connection has a main path and two back-up paths, so that the connection can survive even two faults. In principle, the choice of which of the restoration paths to use can be implemented by controlling the electrical switch to couple a different transponder, or by retuning a tunable transponder or by controlling the optical switch to select a different path through the optical switch.

The alternative restoration path can have a fourth transponder, and a fourth wavelength, between the fourth transponder and the optical switch, and the electrical selector being arranged for selecting whether the first or the second of the connections is coupled to the fourth wavelength, according to the controller. This is one way of providing the second back up path to enable 3-way restoration, with one or two main connections having or sharing two back up paths. By using the electrical selector to couple a different transponder, rather than retuning a transponder or altering the optical path using the optical switch, the delays involved in allowing the optical path to settle can be reduced or avoided.

The connection controller can be arranged to cooperate with other nodes to allow at least part of the restoration path or alternative restoration path to be shared by other restoration paths for restoring other connections. This can enable more efficient use of wavelength resources.

The connection controller can be arranged to restore the third connection if the third wavelength is faulty, using at least part of the first restoration path or the alternative restoration path, by selecting whether the third connection is coupled to either the first restoration path or to the alternative restoration path. This can enable the two restoration paths to be shared by the first and third connections, added or dropped at the present node, for more efficient use of wavelength resources.

The optical switch can comprise a number of wavelength selective switch parts (WSS) each associated with one of the optical line ports, each WSS having an outgoing section for selectively coupling optically a number of wavelengths from other WSSes, to the respective associated optical line port, and an incoming part to selectively couple optically a number of wavelengths from the respective associated port to the other WSSes. The distributed or modular nature of such optical switch can help avoid some of the costs of implementing a more integrated matrix type optical switch.

At least the first of the transponders can be coupled to more than one of the wavelength selective switch. This can make it easier to provide a direction-less transponder to provide more possible paths.

There can be a pool of shared resources available to be reserved for the restoration of many different connections on different main paths. In known systems, such resources are kept free until a fault occurs on the first or on the second lightpath. Then optical couplers/splitters and switches are used in node A and node Z to divert the traffic in the shared transponder in case of failure. Instead of this, embodiments of the present invention can have an additional interface such as a port to connect the second connection in the form of for example tributary best effort traffic. The new port is required in node A and in node Z in the example shown.

In the event of fault that impacts on one of the worker paths, the best effort traffic is disrupted, the shared resources are freed and the traffic affected by the fault is diverted on the booked (shared) restoration path thanks to the electrical selector.

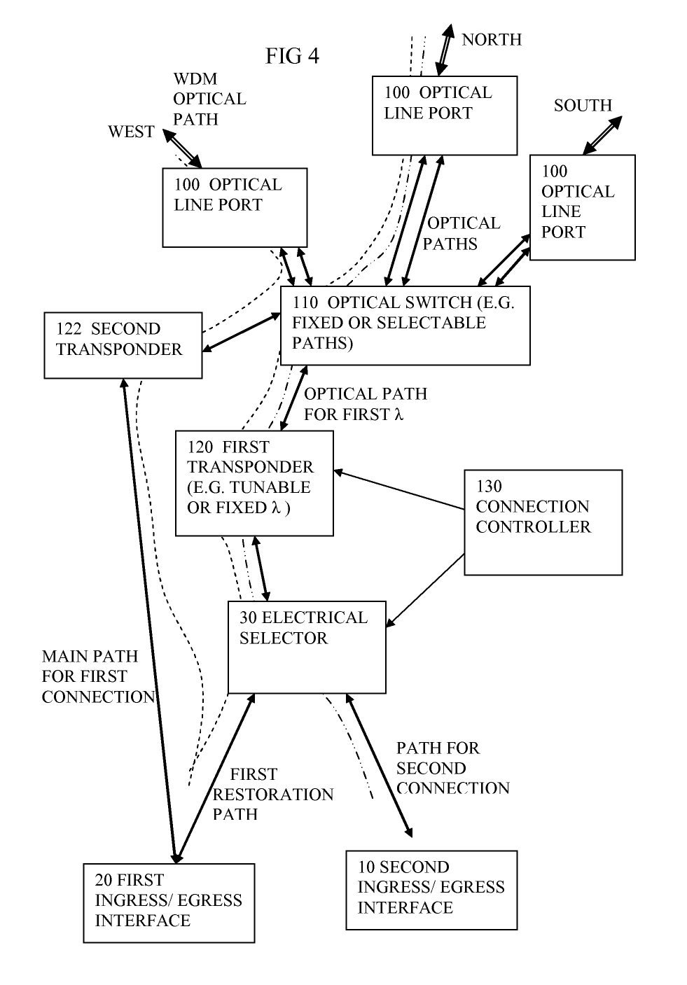

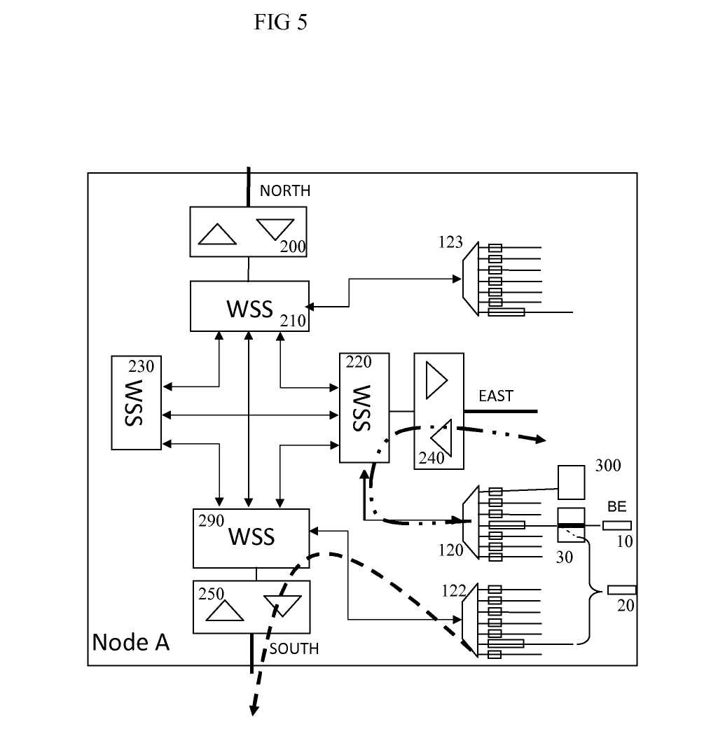

### FIG. 4 Node View

FIG. 4 shows a node view of an example of a node according to a first embodiment, and suitable for use as node A or Z in FIG. 1 or 2. This shows the electrical selector 30 coupled to electrical paths from the first 20 and second 15 interfaces for the first and second (best effort) connections. This selects one of the connections for the first transponder 120, for example a tunable lambda or fixed lambda type. The optical side of the transponder is coupled to an optical switch 110 which may have selectable or fixed wavelength paths between its inputs and outputs. There is a second transponder 122 to couple the first connection to the optical switch and hence to one of the optical line ports 100. In this case three are shown (north east and west), there could be more. Having three such ports means the nodes can be linked in a mesh or in interconnected rings for example. These ports have WDM optical paths to other nodes. As shown, multiple individual wavelength paths are fed to each of the optical line ports from the optical switch. A dashed line shows the path through this node for the main or worker path for the first connection, through the second transponder, and the optical switch and the west optical line port, similar to the path shown in FIGS. 1 and 2. Another dashed line shows how the path changes after a fault, to go via the electrical selector, the first transponder, the optical switch and the north optical line port. A double dot-dash line shows the path taken by the second connection through the electrical selector, the first transponder, the optical switch and the north optical line port. If the optical switch is a passive device, then the direction taken by incoming wavelengths depends on the wavelength and so is controlled by the choice of, or tuning of, the transponders. If it is an active optical switch then the direction taken by a given wavelength can be controlled by the connection controller.

An example of a connection is a 10 GB Ethernet connection. The transponders can be arranged as OTN framing devices to wrap this signal with OTN ODU2 framing signals, before sending it on a single wavelength. Other types of connection with other framing or without such framing can be envisaged.

### FIG. 5, 6 Node View Using WSS and Multiplexing Transponders

FIG. 5 shows a schematic view of a node according to another embodiment. This is similar to the node of FIG. 4, but the optical switch is formed of a number of sections, wavelength switching sections WSS, 210, 220, 230, 290 each associated with one of the optical line ports. Each WSS has an input side and an output side. Optical line ports 200, 240, 250 are shown, which may have wavelength division multiplexing and de multiplexing parts. Each WSS has an associated bank of transponders 120, 122, 123. These each handle a different wavelength and these wavelengths are multiplexed or bundled to reach the associated WSS where the individual wavelengths can be directed to different ones of the optical line ports. Optionally a single wavelength is selected from the bank of transponders to reach the WSS. In cases where all wavelengths are fed to the WSS, each of the transponders can be coupled to it own electrical selector. One further electrical selector 300 is shown, others are not shown for the sake of clarity. Again the WSS can be passive devices, in which case the direction taken by incoming wavelengths depends on the wavelength and so is controlled by the choice of, or tuning of, the transponders. If the WSS is an active device then the direction taken by a given wavelength can be controlled by the connection controller. The operation of the node can be similar to the operation described above for FIGS. 1 to 4. The second connection 10 carrying best effort traffic BE is normally coupled to the restoration path, shown as a double dot dashed line, if there is no fault.

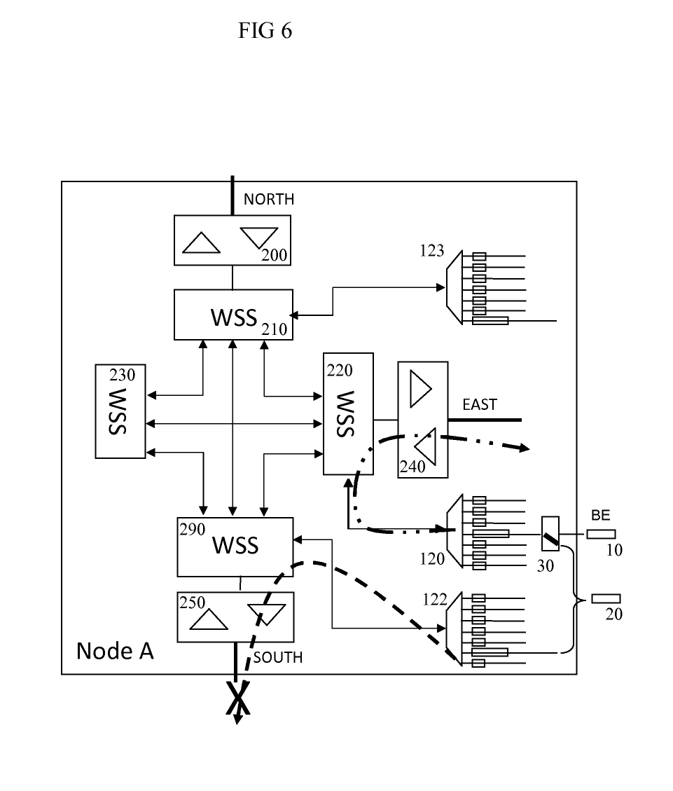

FIG. 6 shows the same node in the state where there is a fault, and the electrical selector is altered as shown, controlled by the connection control part, to enable the first connection to be coupled to the first transponder to use the restoration path through WSS 220 and optical line port 240.

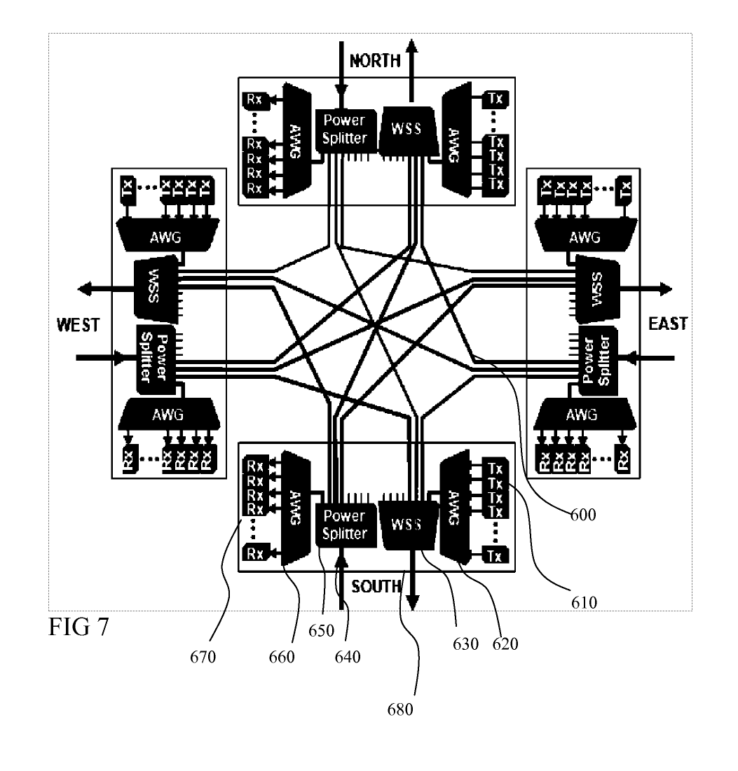

### FIG. 7, Node View

FIG. 7 shows another node view showing more detail of a way of implementing the WSS and the transponders. It shows a node which could be used as a hybrid node, or could be part of a multi layer node, if combined with some switching of the added or dropped electrical signals at another layer. It shows four similar modules labelled north, south, east and west, each of which have similar components, so only south, 680, will be described further. This shows an optical power splitter 650 arranged to receive an incoming single wavelength signal and broadcast this over four or more optical outputs in the form of waveguides generally labelled 600 to the other three or more modules, and to one local drop path, local to that module. This drop path leads to an array wave guide 660 which has an optical wavelength demux or separation function, for separating different wavelengths onto separate physical paths to receivers Rx 670. These receivers output electrical signals which can be fed to further electrical circuits for TDM demux or electrical switching for example, or straight to local destinations such as local networks.

The module also has a wavelength selective switch WSS 640, for selecting one or more wavelengths to be sent out on the outgoing path from the south module. This WSS receives wavelengths from other modules East, North, and West along internal waveguides labelled generally as 600, and one or more wavelengths for adding at that module. The added wavelength is selected by AWG 620 which combines different physical paths from separate transmitters 610 for each wavelength, onto a single input of the WSS. Any one of the transmitters can be activated, which determines which wavelength is being added. An electrical signal to be added can be fed from the electrical selector (not shown in this view to the appropriate transmitter for the desired wavelength. To be able to send out WDM signals, the WSS could be made as a WDM multiplexer, or a WDM multiplexer could be provided downstream of the WSS. In this case, the AWG could feed the WDM multiplexer directly, bypassing the WSS.

The arrangement is direction bound if a client signal added in a transponder coupled with an optical switch is always directed in a wavelength sent to the same optical line port coupled with the WSS and a wavelength coming from an line optical port is always directed to the same one of the transponders.

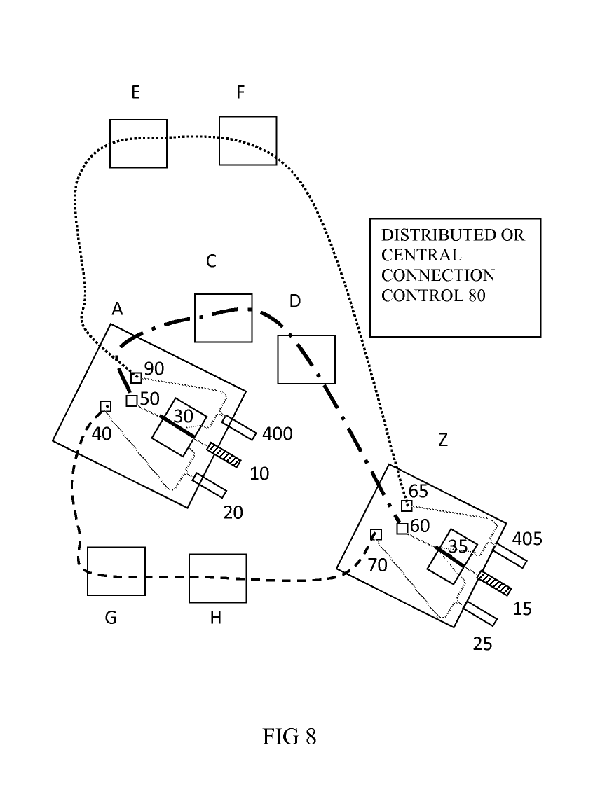

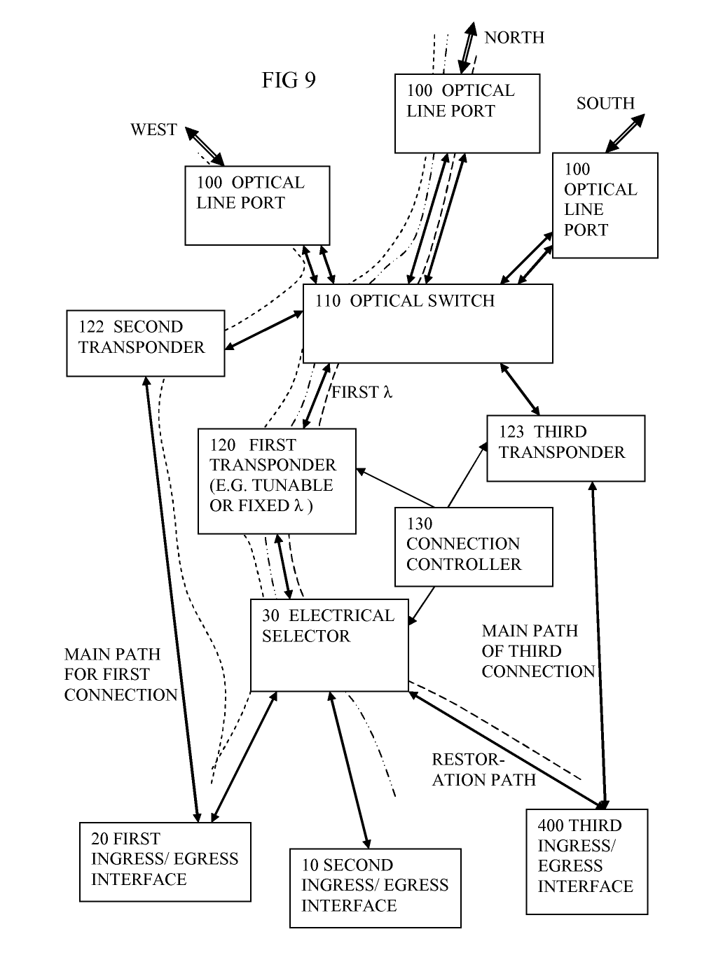

### FIGS. 8, 9, 10, Restoration Path Shared by First and Third Connections

FIG. 8 shows a network view similar to that of FIG. 1 or 2, but with a third connection 400, 405 arranged to share the restoration path. The electrical selectors have three positions. The third connection is normally routed (shown by a dotted line) through third transponders 90 in node A and 65 in node Z, and through nodes E and F. The electrical selectors 30 and 35 are arranged to select the second connection 10, 15 to use the restoration path via nodes C and D, if there is no fault. In the event of a fault on the main path for the third connection, the selectors at nodes A and Z can be controlled to couple the third connection 400, 405 to the first transponder 50, 60, to send the third connection over the restoration path via nodes C and D in place of the second connection. If there are simultaneous faults on the main paths for the first and third connection, a decision would need to be made as to which of these connections would have priority to use the restoration path.

FIG. 9 shows a node view of a similar arrangement. This view is similar to the view of FIG. 4, but with the addition of the third connection having a main path from a third ingress or interface 400 through the third transponder 123 to the optical switch. A restoration path for the third connection is shown as a dashed line from the interface 400 into the electrical selector, and via the first transponder to the electrical switch and out on one of the optical line ports, in this case the north port. As in FIG. 8, in the event of a fault on the main path for the third connection, the electrical selector can be controlled by the connection controller 130, in cooperation with a similar connection controller at the other end of the restoration path, to route the third connection over the restoration path, in place of the second connection.

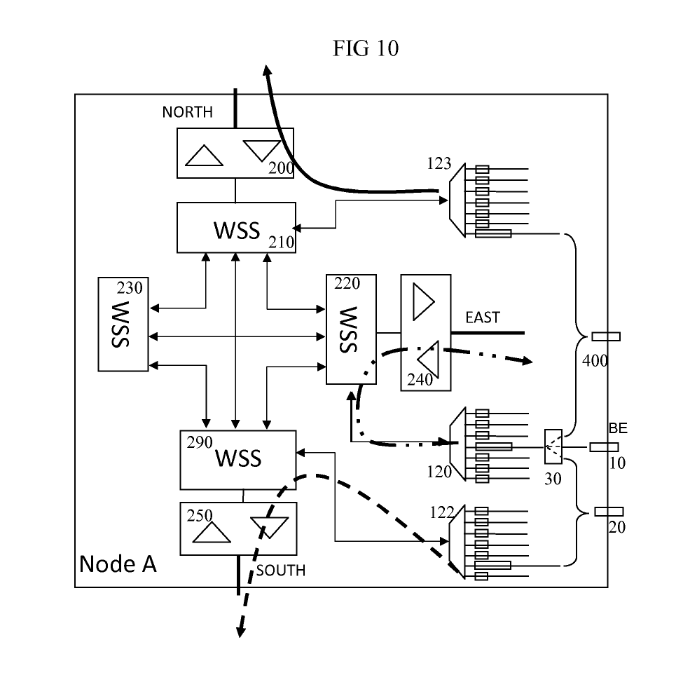

FIG. 10 shows a node view of another embodiment, again having a third connection, so that the restoration path is shared, so that it can restore either the first or the third connection. This view is similar to the view of FIG. 5, but with the addition of the third connection having a main path (shown as a solid line) through the third transponder 123 and the WSS 210, and out via optical line port 200. In the event of a fault, the electrical selector can be controlled by the connection control part, in cooperation with a similar connection controller at the other end of the restoration path, to route the third connection over the restoration path, through WSS 220 and optical line port 240, in place of the second connection.

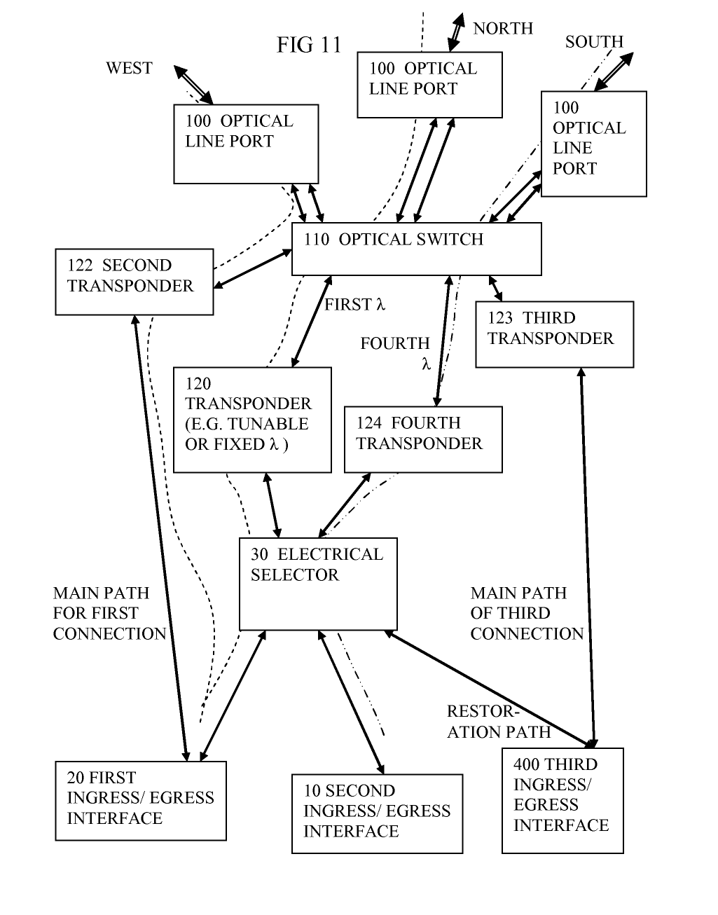

### FIGS. 11, 12, 13, 14, Three Way Restoration

FIG. 11 shows a node view of another arrangement having an alternative restoration path. This view is similar to the view of FIG. 4, but with the addition of the alternative restoration path from the electrical selector 30 via a fourth transponder 124 coupled to the optical switch, and out via the south optical line port 100, shown by the double dot dash line. The electrical selector can be arranged to send best effort traffic over this alternative restoration path, until it is needed for restoration. Then the electrical selector can be controlled to send either the first or the third connection over this alternative restoration path, as needed. This means there are two possible restoration paths for use, so this is effectively a three way restoration scheme.

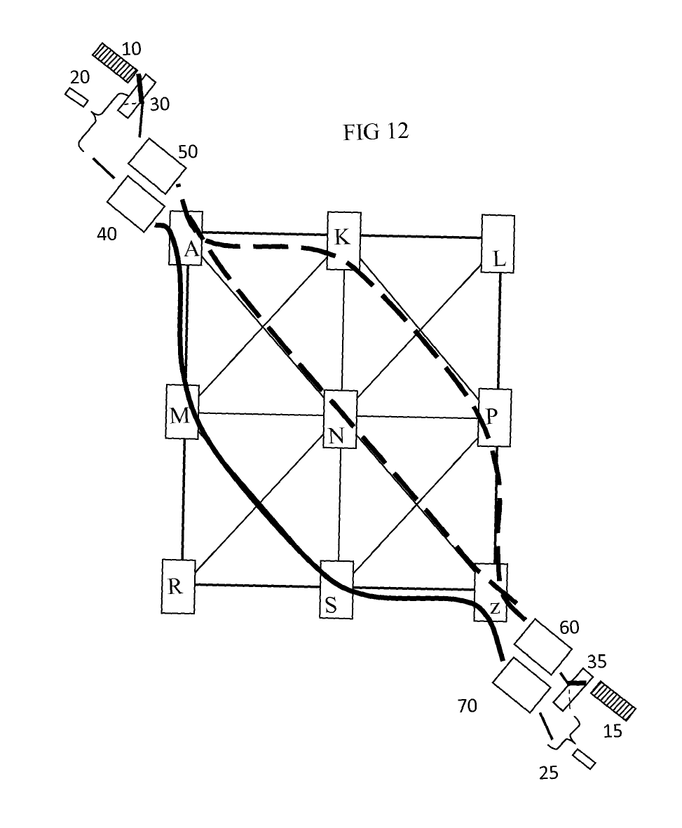

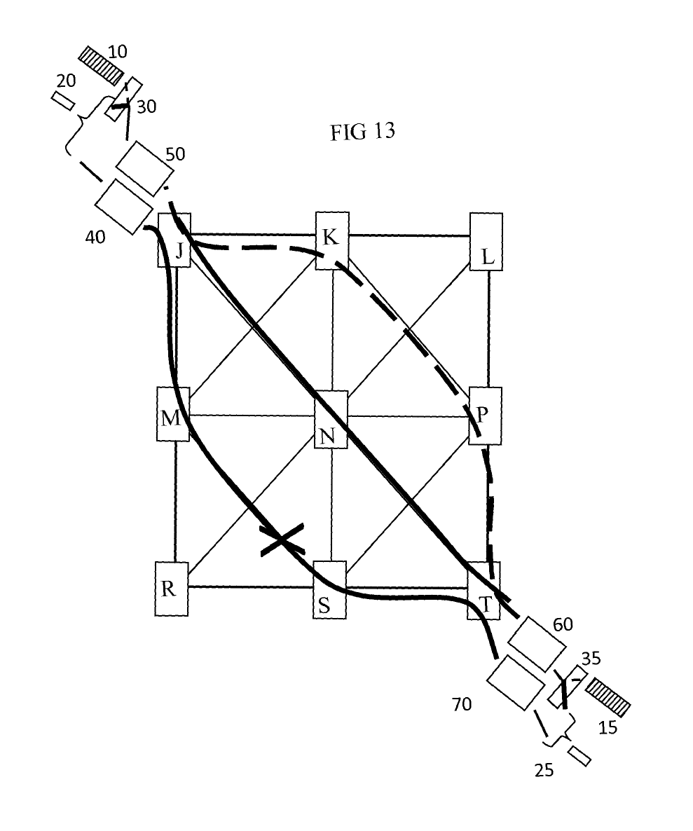

FIGS. 12, 13 and 14 show a network view with a similar scheme, showing a sequence of events. In FIG. 12, nodes A, K, L, M, N, P, R, S and Z are shown, with links to form a mesh network. A main path is set up from node A to node Z via nodes M and S with a first restoration path via node N, and an alternative restoration path via nodes K and P. Parts within nodes A and Z are shown, using similar reference signs to those of FIGS. 1 and 2. In FIG. 12, the electrical selectors 30 and 35 are set to enable the second connection to use the first restoration path or the alternative restoration path.

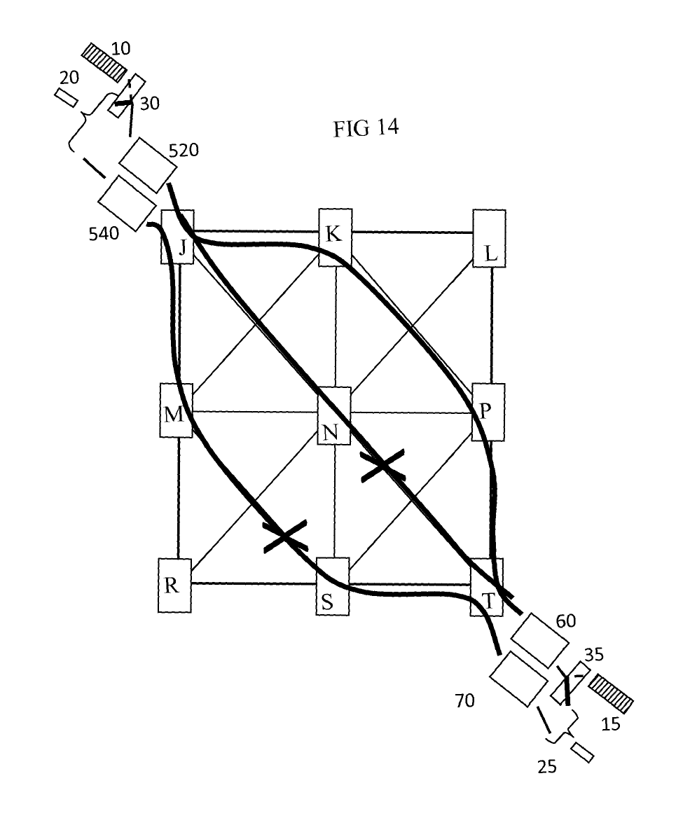

In FIG. 13, a fault on the main path is shown, so the selectors are set to have the first connection restored by using the first restoration path. In FIG. 14, there is a fault on the first restoration path and the first connection is switched to use the alternative restoration path. This can be achieved in various ways, either by optical switching in the optical switch in nodes J and T, or by providing an electrical selector as in FIG. 11 with two paths to different transponders, or by providing a tunable transponder to output a different wavelength which will then be routed along a different path by the optical switch, even if the optical switch is passive.

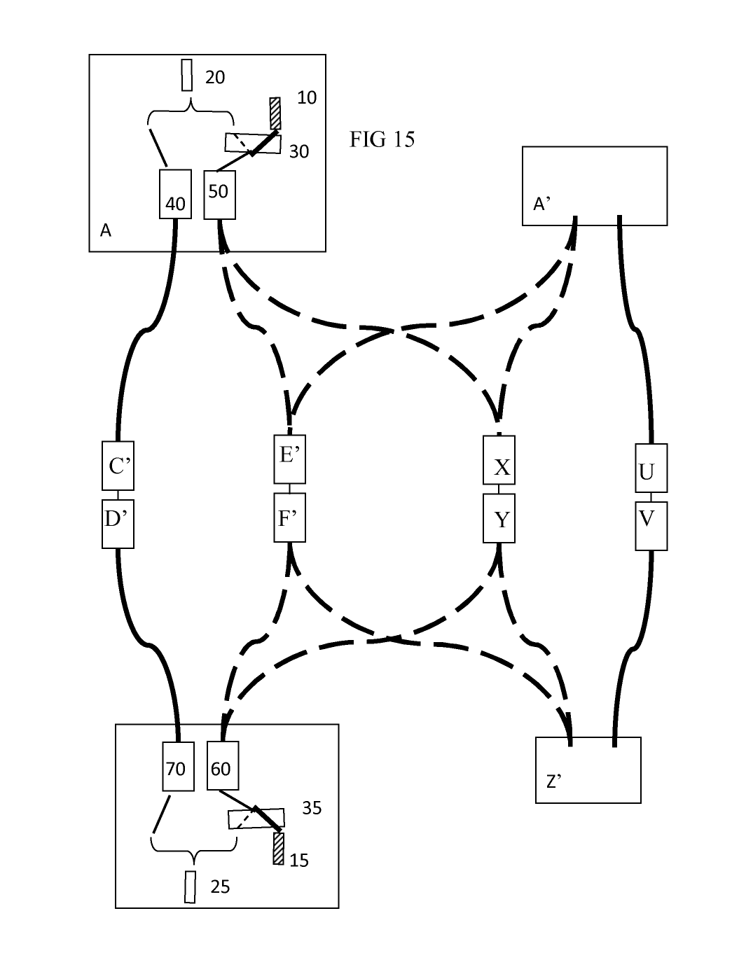

### FIG. 15 Shared 3-Way Restoration

FIG. 15 shows an example in which the first and alternative restoration paths use links which are also used for as restoration paths for another main path. Hence the restoration paths are shared, as well as being used for extra traffic. As well as nodes A and Z as described in relation to FIGS. 12 to 14, with a main path extending via nodes C′ and D′, the other main path in FIG. 15 extends between nodes A′ and Z′, via nodes U and V. The first restoration path for nodes A and Z goes via nodes E′ and F′, and its alternative restoration path is set up via nodes X and Y.

For the other main path between nodes A′ and Z′, the first restoration path is set up via nodes X and Y, while its alternative restoration path is set up via nodes E′ and F′. This means that links between E′ and F′, and X and Y respectively are reserved for more than one restoration path. This implies that some prioritization will be needed if more than one connection needs restoring at the same time, since the reservations are no longer exclusive reservations. This can be carried out by the connection control part.

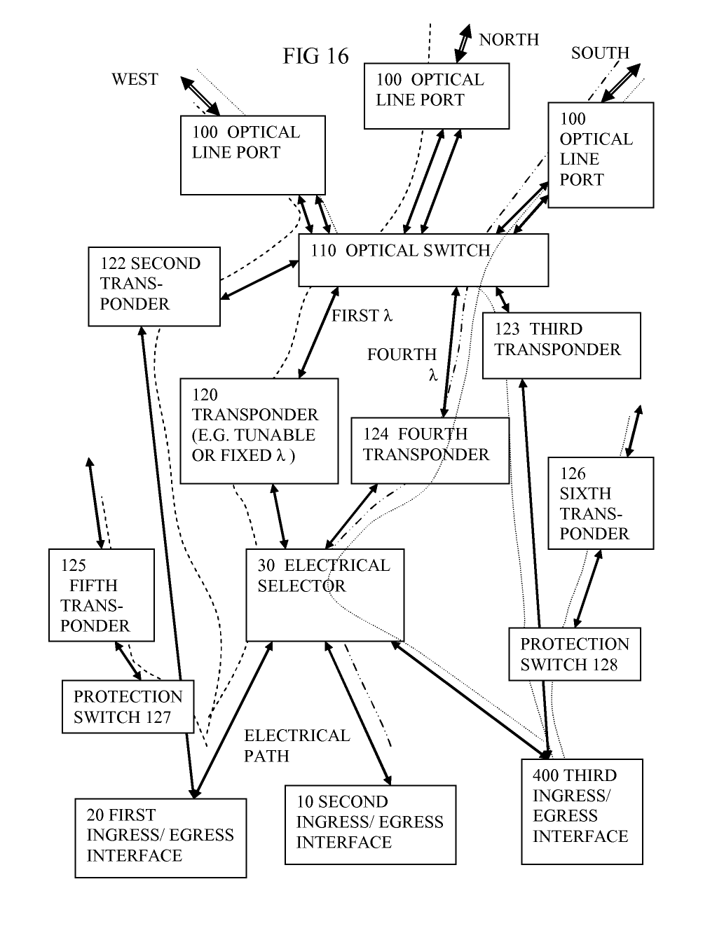

FIG. 16 Restoration with Protection

FIG. 16 shows a node view of an embodiment combining protection switching on the main paths, with the restoration paths already described with reference to FIG. 11.

This can be implemented in various ways, in the example shown an automatic protection switch 127 is inserted in the electrical path for the first connection, and a fifth transponder 125 is provided to give a separate duplicate optical path for the first connection. Similarly for the third connection, a duplicate path is provided by protection switch 128 and sixth transponder 126. The duplicate path is usually switched at the receiving end. The protection switching would usually occur more quickly than any restoration, so the restoration would only be triggered if there is a fault on both the main path and the protection path.

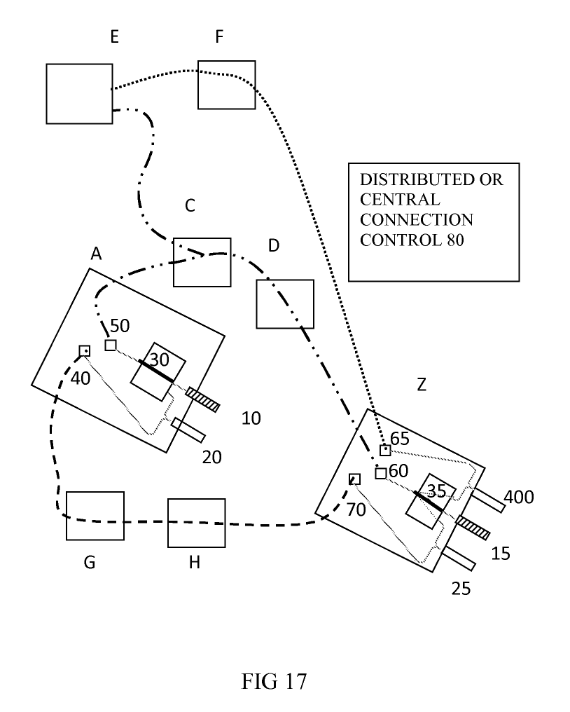

### FIG. 17 Extra Traffic Uses Only Part of the Restoration Path

FIG. 17 shows node view of another example showing a third connection extending to a different end node than that used by the first connection. This means the restoration path shared by the first and third connections is only shared over part of its path. As shown, the third connection extends from node Z via node F to node E. In this situation, the best effort traffic can be inserted in node A or in node E for example. At node C the restoration path branches to or from node E when restoring the third connection or to or from node A when restoring the first connection. So, node C needs to be set up appropriately by the connection controller when the restoration path is used. The provisioning of this best effort services using a traditional unprotected lightpath from node A and node Z would have required two transponders and all the required hardware in between (instead of the proposed reuse of existing shared hardware). Although relatively simple examples have been described, the concepts are extendible to more complicated recovery schemes like the already cited 3-way restoration or safe OSNCP. In 3-way restoration, for example, where two worker paths shares two protection paths (to survive to the double fault), two best effort services can be transported using these shared resources.

### CONCLUDING REMARKS

As has been described, a node for an optical network has an electrical selector (30,35) coupled to a first transponder for selecting which of first or second connections, is carried. A connection controller (80, 130) cooperates with other nodes to set up the first connection on a path using a second transponder, and to reserve a first restoration path for the first connection. A second connection (best effort traffic) is set up on at least part of the reserved first restoration path by controlling the electrical selector. If the path for the first connection fails, the connection controller restores the first connection by controlling the electrical selector to select the first connection for the first restoration path in place of the second connection. By having an electrical selector, a change can be made more rapidly than if done only optically.

The reuse of spare/shared capacity to serve best effort traffic (or low priority “silver” traffic) can be implemented across a WSON domain without affecting the QoS guaranteed traffic (or high priority “gold” traffic). There can be a hardware saving by avoiding to set up new unprotected connections to serve the best effort traffic. These schemes can be implemented utilizing the same network state information necessary to implement the shared recovery schemes. The concept of “best effort” traffic (which is a well known concept in the packet/IP world) can now be extended also into the control of the WSON domain.

Other variations and embodiments can be envisaged within the claims.

1. A node for a wavelength switched optical network, the node having:
three or more optical line ports, for multiplexing wavelengths to carry traffic to other nodes of the network,
an optical switch coupled to the optical line ports for selectively coupling different wavelengths from one of the optical line ports, to others of the optical line ports,
first and second ingress interfaces for receiving the traffic to be carried on the wavelengths to the other nodes,
a first transponder for converting electrical signals carrying the traffic from either of the interfaces into wavelengths carrying the traffic for output to the other nodes via the optical switch and the optical line ports,
an electrical selector coupled to the first and second interfaces, and arranged to pass traffic selectively from either the first or the second interface to the first transponder,
a second transponder coupled to the first interface, for converting electrical signals carrying the traffic from the first interface into wavelengths carrying the traffic for output to the other nodes via the optical switch and the optical line ports,
the node also having a connection controller arranged to cooperate with other nodes to set up a first connection for the traffic over a main path from the first interface through at least the second transponder and the optical switch, and to reserve a first restoration path for the first connection from the first interface through at least the electrical selector, the first transponder, and the optical switch, the connection controller also being arranged to set up a second connection from the second interface on at least part of the reserved first restoration path by controlling the electrical selector to couple the traffic from the second interface to the first transponder;
the connection controller being arranged to restore the first connection if the main path fails, by controlling the electrical selector to pass traffic from the first interface to the first transponder.

2. A node for a wavelength switched optical network, the node having:
three or more optical line ports, for de multiplexing wavelengths carrying traffic from other nodes of the network,
an optical switch coupled to the optical line ports for selectively coupling different wavelengths from one of the optical line ports, to others of the optical line ports,
first and second interfaces for the traffic dropped from the wavelengths received from the other nodes,
a first transponder coupled to the optical switch for converting wavelengths from the optical switch carrying the traffic to be dropped, into electrical signals to pass to either of the interfaces,
an electrical selector coupled to the first transponder and arranged to pass the traffic from the first transponder selectively to either the first or to the second interface,
a second transponder coupled to the optical switch, for converting wavelengths from the optical switch carrying the traffic to be dropped, into electrical signals to pass to the first interface,
the node also having a connection controller arranged to cooperate with other nodes to set up a first connection for the traffic over a main path to the first interface through at least the second transponder and the optical switch, and to reserve a first restoration path for the first connection to the first interface through at least the optical switch, the first transponder, and the electrical selector, the connection controller also being arranged to set up a second connection to the second interface on at least part of the reserved first restoration path by controlling the electrical selector to couple the traffic to the second interface from the first transponder;
the connection controller being arranged to restore the first connection if the main path fails, by controlling the electrical selector to pass traffic from the first transponder to the first interface.

3. The node of claim 1, the transponders comprising non-tunable transponders, for carrying out at least one of transmitting and receiving a fixed wavelength.

4. The node of claim 1, the transponders comprising tunable transponders, controllable by the connection controller to carry out at least one of transmitting and receiving different wavelengths.

5. The node of claim 1, the optical switch having at least some fixed wavelength paths, so that a respective wavelength at one input of the optical switch is always directed to the same output.

6. The node of claim 1, the optical switch having some selectable wavelength paths, so that a respective wavelength at one input of the optical switch is directed to either of two or more outputs of the optical switch, under the control of the connection controller.

7. The node of claim 1, having a third transponder coupled to a third interface, for converting electrical signals carrying the traffic from the third interface into wavelengths carrying the traffic for output to the other nodes via the optical switch and the optical line ports,
the connection controller being arranged to cooperate with other nodes to set up a third connection for the traffic over a main path from the third interface through at least the third transponder and the optical switch, and to reserve a first restoration path for the third connection from the third interface through at least the electrical selector, the first transponder, and the optical switch, the connection controller being arranged to restore the third connection if its main path fails, by controlling the electrical selector to pass traffic from the third interface to the first transponder.

8. The node of claim 2, having a third transponder coupled to a third interface, for converting wavelengths carrying the traffic from the other nodes via the optical line ports and the optical switch into electrical signals carrying the traffic to the third interface,
the connection controller being arranged to cooperate with other nodes to set up a third connection for the traffic over a main path to the third interface through at least the optical switch and the third transponder, and to reserve a first restoration path for the third connection to the third interface through at least the optical switch, the first transponder, and the electrical selector, the connection controller being arranged to restore the third connection if its main path fails, by controlling the electrical selector to pass traffic from the first transponder to the third interface.

9. The node of claim 1, the connection controller being arranged to cooperate with other nodes to reserve an alternative restoration path for restoration of the first connection, and to control one or more of the electrical switch, the transponder, and the optical switch, to couple the first connection to the alternative restoration path to restore the first connection if the first restoration path is faulty.

10. The node of claim 9, the alternative restoration path comprising a fourth transponder, coupled between the electrical selector and the optical switch, and the connection controller being arranged to control the electrical selector to select whether the first or the second of the connections uses the alternative restoration path.

11. The node of claim 9, the connection controller being arranged to cooperate with other nodes to allow at least part of the restoration path and the alternative restoration path to be shared by other restoration paths for restoring other connections.

12. The node of claim 11, the connection controller being arranged to control whether the third connection is restored by using at least part of the first restoration path or by using at least a part of the alternative restoration path.

13. The node of claim 1, the optical switch comprising a number of wavelength selective switch parts each associated with one of the optical line ports, each switch part having an outgoing section for selectively coupling optically a number of wavelengths from other sections, to the respective associated optical line port, and an incoming section to selectively couple optically a number of wavelengths from the respective associated port to the other sections.

14. The node of claim 13, at least the first of the transponders being coupled to more than one of the wavelength selective switch parts.

15. A connection controller for setting up connections between nodes in a wavelength switched optical network having wavelength multiplexed optical paths between optical line ports of neighbouring nodes of the network, at least an ingress node and an egress node having: an optical switch coupled to the optical line ports for selectively coupling different wavelengths from one of the ports, to the other ports, first and second transponders for electrical to optical conversion in the ingress node and for optical to electrical conversion in the egress node, and an electrical selector coupled to the first of the transponders for selecting which of the first and second connections, uses the first of the transponders, the ingress node having first and second interfaces and the egress node having first and second interfaces,
the connection controller having a processor and a communications interface for cooperating with the nodes of the network, the processor being arranged to:
use the communications interface to cooperate with the nodes to set up the first connection on a main path using the second transponders at the ingress node and at the egress node, and to:
reserve a first restoration path for the first connection from the first interface through the electrical selector to the first transponder at the ingress node and the first transponder at the egress node to the electrical selector and then to the first interface, and to set up the second connection on at least part of the reserved first restoration path by controlling the electrical selectors at the ingress node and the egress node to couple the second connection from the second interface through the electrical selector, through the first transponder, and at the egress node through the first transponder and through the electrical selector to the second interface,
and to restore the first connection if the main path for the first connection fails, by using the first restoration path by controlling the electrical selector in the ingress node to couple the first interface to the first transponder and by controlling the electrical selector in the egress node to couple the first transponder to the first interface.

16. A method of operating an ingress node having:
three or more optical line ports, for multiplexing wavelengths to carry traffic to other nodes of the network,
an optical switch coupled to the optical line ports for selectively coupling different wavelengths from one of the optical line ports, to others of the optical line ports,
first and second interfaces for receiving the traffic to be carried on the wavelengths to the other nodes,
a first transponder for converting electrical signals carrying the traffic from either of the interfaces into wavelengths carrying the traffic for output to the other nodes via the optical switch and the optical line ports,
an electrical selector coupled to the first and second interfaces, and arranged to pass traffic selectively from either the first or the second interface to the first transponder,
a second transponder coupled to the first interface, for converting electrical signals carrying the traffic from the first interface into wavelengths carrying the traffic for output to the other nodes via the optical switch and the optical line ports, the method having the steps of:
setting up a first connection for the traffic over a main path from the first interface through at least the second transponder and the optical switch,
reserving a first restoration path for the first connection from the first interface through at least the electrical selector, the first transponder, and the optical switch,
setting up a second connection from the second interface on at least part of the reserved first restoration path by controlling the electrical selector to couple the traffic from the second interface to the first transponder;
restoring the first connection if the main path fails, by controlling the electrical selector to pass traffic from the first interface to the first transponder.

17. A method of operating an egress node having:
three or more optical line ports, for demultiplexing wavelengths carrying traffic from other nodes of the network,
an optical switch coupled to the optical line ports for selectively coupling different wavelengths from one of the optical line ports, to others of the optical line ports,
first and second interfaces for the traffic dropped from the wavelengths received from the other nodes,
a first transponder coupled to the optical switch for converting wavelengths from the optical switch carrying the traffic to be dropped, into electrical signals to pass to either of the interfaces,
an electrical selector coupled to the first transponder and arranged to pass the traffic from the first transponder selectively to either the first or to the second interface,
a second transponder coupled to the optical switch, for converting wavelengths from the optical switch carrying the traffic to be dropped, into electrical signals to pass to the first interface, the method having the steps of:
setting up a first connection for the traffic over a main path to the first interface through at least the second transponder and the optical switch,
reserving a first restoration path for the first connection to the first interface through at least the optical switch, the first transponder, and the electrical selector,
setting up a second connection to the second interface on at least part of the reserved first restoration path by controlling the electrical selector to couple the traffic to the second interface from the first transponder, and
restoring the first connection if the main path fails, by controlling the electrical selector to pass traffic from the first transponder to the first interface.

18. Computer readable instructions on a computer readable medium, which when executed by a processor cause the processor to carry out the method of claim 16.
